(19) United States
(12) Patent Application Publication
(10) Pub. No.: US 2011/0312261 A1
(43) Pub. Date: Dec. 22, 2011

(54) Portable dust collection system

(76) Inventor: Louis W. Cappuccio, Hammonton, NJ (US)

(21) Appl. No.: 12/803,235

(22) Filed: Jun. 22, 2010

(51) Int. Cl. B08B 15/02

(52) U.S. Cl. 454/63

(57) ABSTRACT

A portable dust collection system utilizes a dust collection enclosure formed by a material covering overlaying a collapsible frame. The enclosure is opened at its front end and tapers towards its back end, where there is a frustum-shaped chamber which receives and discharges the collected dust from the enclosure. A vacuum blower unit is utilized to suck the dust from the enclosure chamber and discharge it through a flexible conduit to a dust accumulation container. Dust entering the container is intermixed with water which is recirculated from within the container through water lines and nozzle elements. The water entraps the dust, forming a mixture which falls to the bottom of the dust accumulation chamber. A fluid discharge line is provided on the container for removal of the water and dust mixture.

### BACKGROUND OF THE INVENTION

One of the many hazards faced by construction workers and laborers in the field is the threat of breathing in dust and dirt which is created by the very work being done. For instance, carpenters, insulators, plumbers, pipefitters and many others in the construction trade routinely cut dust creating material or are subjected to dust from such materials. These materials include, but are not limited to, wood, fiberglass, plastics, asbestos, concrete and certain metals. Even those who commonly work outdoors, like hardscapers, must cut and shape concrete pavers which emit large amounts of dust when they are cut.

Continued breathing of dust which emanates from these sources can result in a variety of serious lung related diseases, e.g. silicosis, asbestosis, pneumoconiosis, and some cancers. Of additional significance is the fact that, if not contained, dust from construction will spread, not only over the working area, but also to adjacent and potentially far reaching property, falling on the ground, trees, vehicles, buildings, etc. See FIG. 1, which depicts the extent of the dispersal of dust without dust containment and collection.

It is thus imperative that dust produced by the cutting of construction materials be captured and contained for the health and well being of workers and the surrounding environment.

There have been attempts to contain dust created during construction or hardscaping operations, but these have mostly involved tool mounted dust collectors or large containment tents in which the dust creating work is performed. Neither of these options, or others which have been proposed, have been practical or truly successful in fully capturing the dust and processing it so that it is not a threat to persons or property. Moreover, there is no system which accomplishes the objective of accumulating and promptly and safely treating the dust, which also can be easily transported and readily set up in any open area worksite.

### SUMMARY OF THE INVENTION

It is thus the object of the present invention to provide a dust collection system which overcomes the limitations and disadvantages of existing systems.

It is the object of the present invention to provide a dust collection system which efficiently and effectively captures and contains substantially all dust created by the cutting, grinding and shaping of raw construction materials, and then processes this dust so that it is not harmful to persons or property.

It is another object of the present invention to provide a dust collection system which has relatively few components and is readily portable, such that it can be set up in any open area worksite, and then easily be taken down and reassembled at another worksite.

It is still another object of the present invention to provide a dust collection system which has a means to process and then simply and conveniently dispose of dust captured by the system.

These and other objects are accomplished by the present invention, a portable dust collection system which comprises a dust collection enclosure formed by a material covering overlaying a collapsible frame. The enclosure is opened at its front end and tapers towards its back end, where there is a frustum-shaped chamber which receives and discharges the collected dust from the enclosure. A vacuum blower unit is utilized to suck the dust from the enclosure chamber and discharge it through a flexible conduit to a dust accumulation container. Dust entering the container is intermixed with water which is recirculated from within the container through water lines and nozzle elements. The water entraps the dust, forming a mixture which falls to the bottom of the dust accumulation chamber. A fluid discharge line is provided on the container for removal of the water and dust mixture.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 depicts a stone or concrete paver cutting operation which does not utilize the dust collection system of the present invention.

FIG. 2 is a modified front view of the dust collection system of the present invention in use.

FIG. 3 is a partial sectional view of the dust collection system of the present invention in use, depicting the flow of dust within the system.

FIG. 4 is a view of the primary components of the dust collection system of the present invention.

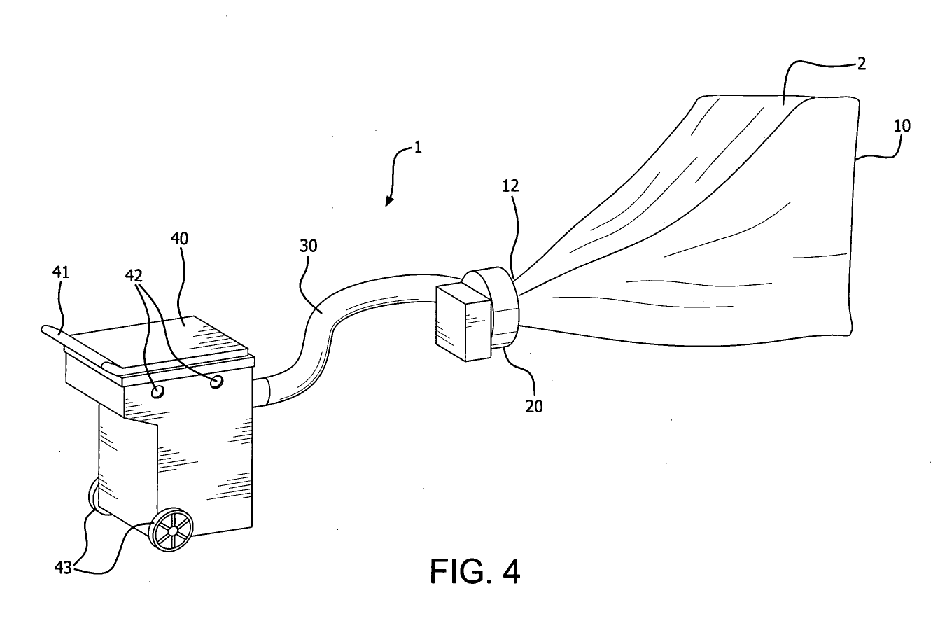

FIG. 5 is a cross-sectional view of the dust accumulator chamber of the dust collection system of the present invention.

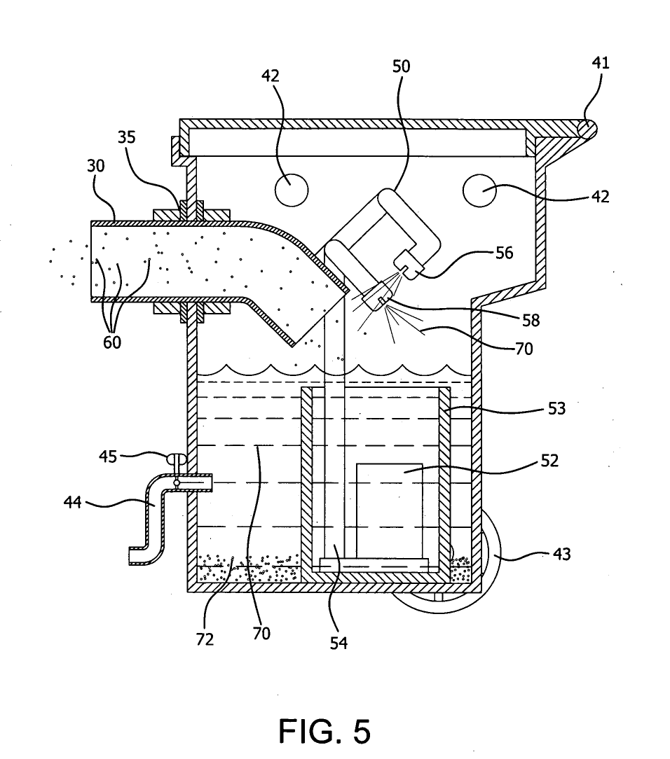

FIG. 6 is a view of the frame of the enclosure of the dust collection system of the present invention, partially collapsed.

FIG. 7 is a view of the frame of the enclosure of the dust collection system of the present invention in portability mode.

### DETAILED DESCRIPTION OF THE INVENTION

Dust collection system 1 is designed to be readily portable with relatively few, but very specific components. The system comprises dust collection enclosure 2, vacuum blower unit 20, dust transport conduit 30, and dust accumulation container 40, containing fluid dispensing system 50.

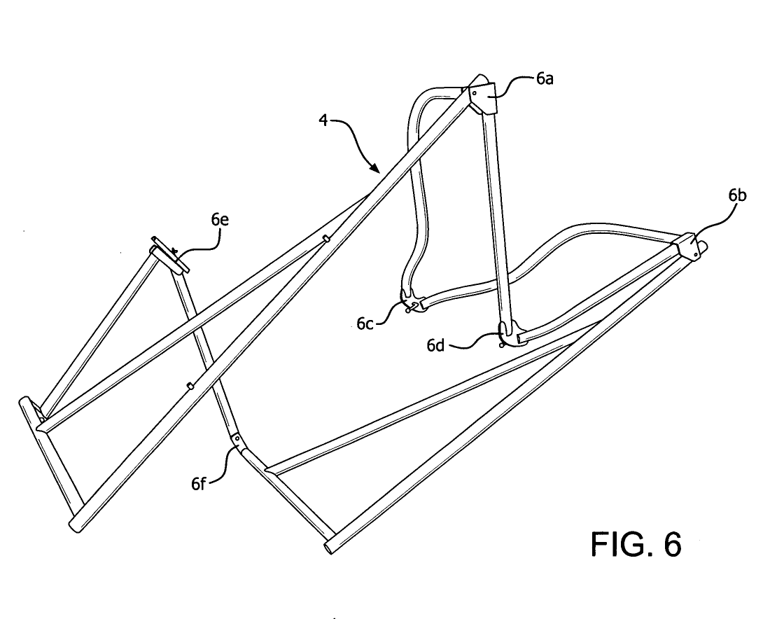

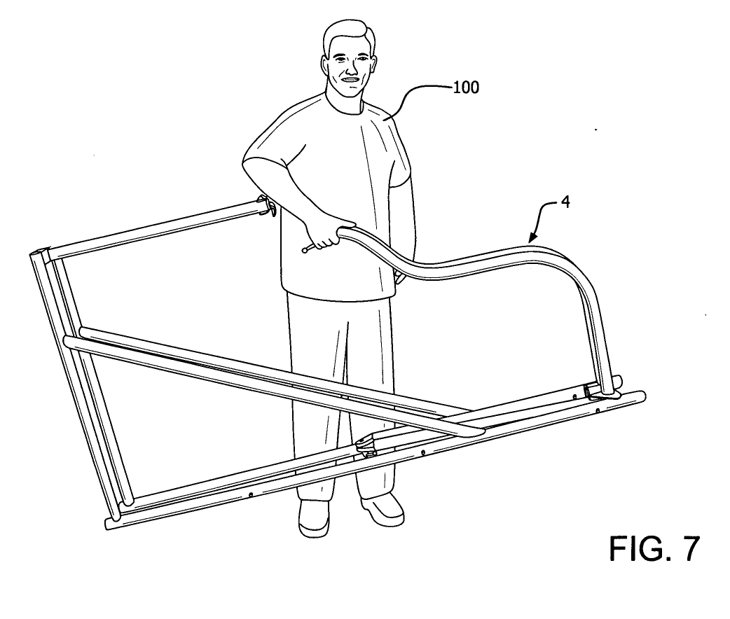

Enclosure 2 comprises frame 4 with appropriate pivoted joints 6a-6f, which permit worker 100 to fully collapse the frame for easy portability. See FIGS. 6 and 7. Frame 4 can be easily opened and set up for use. Enclosure 2 further comprises material covering 8. Once frame 4 is set up, material covering 8 is spread over and secured to the frame by tie lines through grommets or equivalent means (not shown), such that enclosure 2 is open at its front end 10 and tapers rearward toward its back end 12. Covering 8 is secured over frustum shaped chamber 14 at back end 12 of enclosure 2. Chamber 14 is made of lightweight metal, e.g. aluminum, and comprises screen covered opening 16 at its rearmost end.

Thus enclosure 2, with its covering 8 secured tightly over and around chamber 14, is “dust tight” from its front end 10 to opening 16 of chamber 14.

There is an airtight connection between suction area 22 of vacuum blower unit 20 and opening 16 of chamber 14. Discharge 24 of vacuum blower unit 20 is attached to dust transport conduit 30 at airtight connection 32. Conduit 30 should be static-proof and can be a flexible, plastic hose, tube, or equivalent easily positionable line.

Discharge end 34 of conduit 30 is attached via airtight connection 35 to dust accumulation container 40. Container 40 is substantially enclosed and of any convenient shape. Here it is shown with handle 41 and wheels 43 for convenient movement. Container 40 comprises vents 42, opening from its sides, and fluid discharge line 44 controlled via valve 45.

Container 40 houses fluid dispensing system 50. This system is designed to dispense fluid, e.g. water, within container 40. Fluid dispensing system comprises pump 52 surrounded by filter casing 53. Pump 52 recycles fluid through line 54 to nozzle elements 56 and 58 located in the upper region of container 40. Vent 42 provides relief ports to ensure that there is no unsafe build-up of air pressure within container 40.

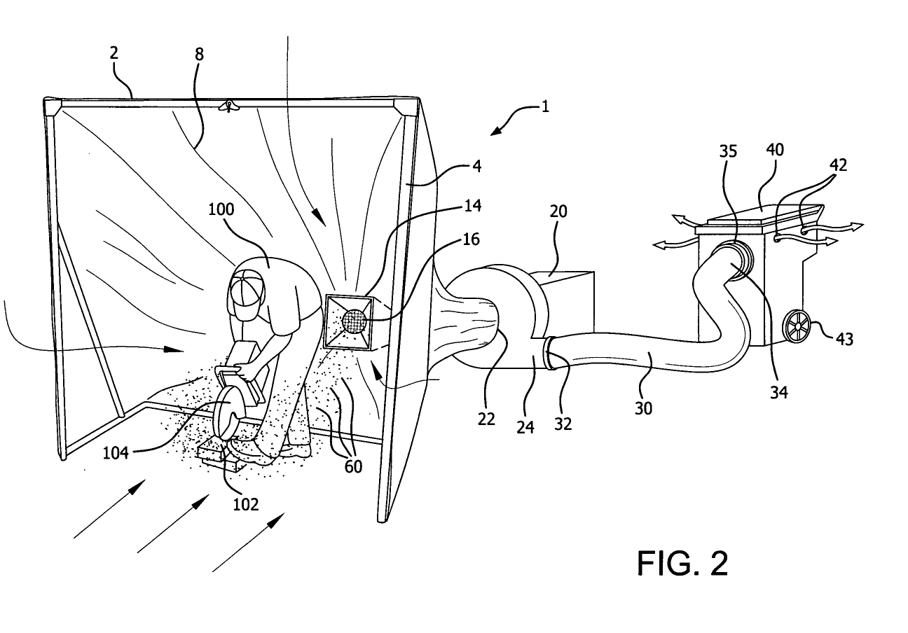

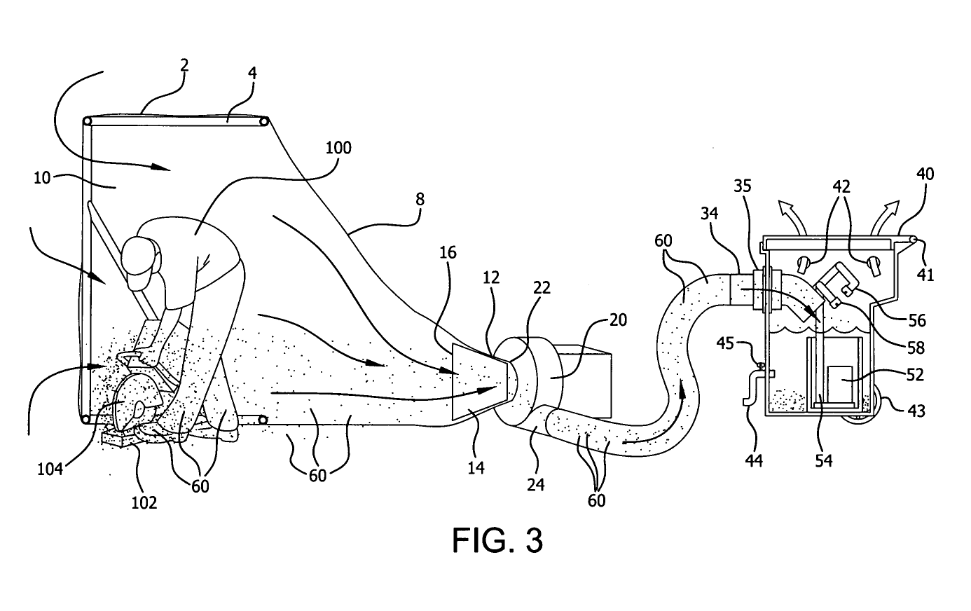

Dust collection system 1 can readily be set up in any location where dust will be an issue due to cutting, grinding, sanding, or otherwise working on stone, metal, wood, or other dust creating material. Dust creating activities will then be performed within enclosure 2, as depicted in FIGS. 2 and 3, showing worker 100 cutting stone or concrete paver 102 with dust producing cutting tool 104. While cutting operations are underway, vacuum blower 20 is turned on. Dust particles 60 emanating from the operation will be maintained within enclosure 2 until it is sucked through screened opening 16 of chamber 14, which receives and collects the dust particles. From chamber 14, dust particles 60 are suctioned into vacuum blower 20 and then are blown through dust transport conduit 30 to container 40. The tapered shape of enclosure 2 and the frustum shape of chamber 14 provide a pressure differential which enhances the flow of dust particles 60 from its source through the enclosure. The flow arrows in FIGS. 2 and 3 depict the path of travel of the dust particles through the various components of the system.

Dust particles 60 proceed through transport conduit 30, where they enter dust accumulation container 40. Pump 52 operates to recirculate water 70 through fluid line 54, to nozzle elements 56 and 58, where the water is sprayed into container 40, into which dust particles 60 have been blown. Sprayed water 70 intermixes with all dust particles 60 entering container 40, forming fluid/dust mixture 72. Most of mixture 72, which traps all incoming dust particles 60, flows harmlessly down to the bottom of container 40, where it is eventually drained out of the container via fluid discharge line 44 when open valve 45 is opened.

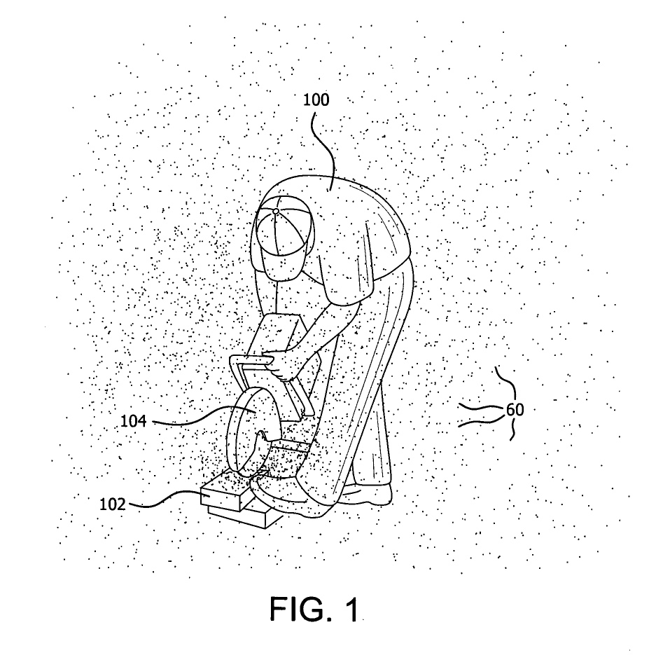

By use of dust collection system 1, no dust is allowed to escape into the air and the dust hazards depicted in FIG. 1 can be avoided. On the contrary, substantially all dust created within enclosure 2 is captured and converted to a harmless dust/fluid mixture.

Certain novel features and components of this invention are disclosed in detail in order to make the invention clear in at least one form thereof However, it is to be clearly understood that the invention as disclosed is not necessarily limited to the exact form and details as disclosed, since it is apparent that various modifications and changes may be made without departing from the spirit of the invention.

1. A portable dust collection system comprising:
enclosure means for the collection of dust resulting from dust creating activities within the enclosure means;
dust collection means for receiving dust from the enclosure means;
means for the removal of the dust from the enclosure means, said removal means providing a suction to the enclosure means, whereby the dust created in the enclosure means is sucked through the dust collection means and out of the enclosure means;
dust accumulator means for receiving and recovering the dust created in the enclosure means, said accumulator means comprising fluid dispensing means for intermixing fluid with the dust, said fluid dispensing means comprising means to recycle fluid within the accumulator means; and
conduit means for transporting dust from the removal means to the accumulator means.

2. The portable dust collection system as in claim 1 wherein the enclosure means comprises a foldable frame having pivotable joints, the frame being fully collapsible into a portable mode.

3. The portable dust collection system as in claim 2 wherein the enclosure means further comprises a covering supported by the frame.

4. The portable dust collection system as in claim 1 wherein the enclosure means has a fully opened front end and the dust collection means is positioned at the back of the enclosure means.

5. The portable dust collection system as in claim 1 wherein the dust collection means comprises a chamber at the back end of the enclosure means, the chamber having a screened covered opening for receiving the dust.

6. The portable dust collection system as in claim 5 wherein the chamber is frustum shaped to enhance gathering of the dust into the opening.

7. The portable dust collection system as in claim 1 wherein the fluid dispensing means comprises fluid carrying lines which spray fluid through nozzle elements located in the upper region of the accumulator means and the fluid recycling means comprises a pump located at the bottom of the accumulator means.

8. The portable dust collection system as in claim 1 wherein the accumulation means comprises a substantially enclosed container which houses the fluid dispensing means and the fluid recycling means, said container further comprising at least one vent extending through the container.

9. A portable dust collection system comprising:
enclosure means for the collection of dust resulting from dust creating activities within the enclosure means, said enclosure means comprising:
a foldable frame having pivotable joints, the frame being fully collapsible into a portable mode;
a covering supported by the frame;
a fully open front end; and
a frustum shaped chamber at the back end, the chamber having a screened covered opening for receiving the dust;
means for the removal of the dust from the enclosure means, said removal means providing a suction to the enclosure means, whereby the dust created in the enclosure means is sucked through the chamber and out the enclosure means;
dust accumulation means for receiving and recovering the dust created in the enclosure means, said accumulation means comprising:
fluid dispensing means for intermixing fluid with the dust, said fluid dispensing means comprising fluid carrying lines which spray fluid through nozzle elements located in the upper region of the accumulation means; and
means to recycle the fluid within the accumulation means, said means comprising a pump located at the bottom of the accumulation means; and
conduit means for transporting dust from the removal means to the accumulation means.

10. The portable dust collection system as in claim 1 wherein the accumulation means comprises a substantially enclosed container which houses the fluid dispensing means and the fluid recycling means, said container further comprising at least one vent extending through the container.

11. The portable dust collection system as in claim 9 wherein the accumulation means comprises a substantially enclosed container which houses the fluid dispensing means and the fluid recycling means, said container further comprising at least one vent extending through the container.
